(19) United States
(12) Patent Application Publication
(10) Pub. No.: US 2006/0271875 A1
(43) Pub. Date: Nov. 30, 2006

(54) A METHOD AND SYSTEM FOR PROVIDING VISUAL ANNOTATION IN A SHARED DISPLAY ENVIRONMENT

(75) Inventors: Brian GREEN, Santa Barbara, CA (US); David Frederic THEURER, Santa Barbara, CA (US); Carey LEFLER, Santa Barbara, CA (US)

Correspondence Address: CHOATE, HALL & STEWART LLP, TWO INTERNATIONAL PLACE, BOSTON, MA, 02110, US

(73) Assignee: CITRIX SYSTEMS, INC., Fort Lauderdale, FL (US)

(21) Appl. No.: 10/908,807

(22) Filed: May 26, 2005

(51) Int. Cl. G06F 9/00

(52) U.S. Cl. 715/768

(57) ABSTRACT

A system and method for focusing attention to an area of a shared display are described. The method includes associating a substantially transparent window with the location of a cursor to position the cursor within the substantially transparent window and changing the appearance of the cursor to highlight a portion of the display.

### FIELD OF THE INVENTION

The invention generally relates to screen sharing and more specifically to focusing attention to a specific area of the shared screen.

### BACKGROUND OF THE INVENTION

One example of a screen sharing application is the GOTOMEETING service offered for use by Citrix Online Division of Santa Barbara, Calif. During a screen sharing session, it is often desirable to focus attention to a specific area of the shared screen. One way to focus attention is to verbally explain the location to the other attendees of the screen sharing session. Another way is to move a pointing device, such as a cursor, to the desired area and rapidly moving the pointing device within a relatively small and constrained area.

Each of these solutions may not achieve the desired focusing effect for a number of reasons. For example, it may be difficult to accurately explain the precise location of interest to all the participants. Additionally, it may be difficult for each of the participants to focus on a rapidly moving pointing device for one reason or another.

At least one screen sharing solution features a “laser pointer” that highlights an area of a shared screen. The laser pointer is captured along with the other elements of the shared screen and transmitted to the participants of the screen sharing session as a portion of an image. As the laser pointer is moved about the shared screen, its position updated on the screens of the other participants of the screen sharing session. The motion of the laser pointer may appear jerky (i.e., not smooth) because the motion of the laser pointer is treated as a change to the shared screen image.

### BRIEF SUMMARY OF THE INVENTION

In one aspect, the invention features a method of highlighting a portion of a display generated by a first device and sharing the display with a second device. The method includes associating a substantially transparent window with the location of a cursor to position the cursor within the substantially transparent window and changing the appearance of the cursor to highlight a portion of the display.

In one embodiment, the method includes moving the location of the substantially transparent window as the position of the cursor changes so the cursor remains associated with the substantially transparent window.

In other embodiments, the method includes intercepting a mouse event from an input device prior to passing the event to an application executing in the shared windows environment, changing the appearance of the cursor comprises changing the appearance of the cursor to a translucent disk, or determining the number of resolution bits used generate the display of the first device and selecting the appearance of the cursor in response to the number of resolution bits used.

In still other embodiments, the associating and cursor change occur at each of the first device and the second device or controlling the z-order of the substantially transparent window relative to other windows of the display generated by the first device.

In another aspect, the invention features a system for highlighting a portion of a display generated by a first device and shared with a second device. The system includes means for associating a substantially transparent window with the location of a cursor to position the cursor within the substantially transparent window and means for changing the appearance of the cursor to highlight a portion of the display.

In still another aspect, the invention features a system for highlighting a portion of a display generated by a first device and being shared with a second device. The system includes an associator module and a display generator. The associator module is in communication with an input device, receives input commands, and locates a substantially transparent window behind a cursor. The display generator is in communication with associator module and changes the appearance of the cursor to highlight a portion of the display.

In one embodiment, the system includes a hooking module in communication with the input device. The hooking module monitors the movements of the location of the substantially transparent window as the position of the cursor changes such that the cursor remains associated with the substantially transparent window. The hooking module can also intercept a mouse event from the input device prior to passing the event to an application executing in the shared windows environment.

In another embodiment, the system also includes a determination module in communication with the display generator. The determination module determines the number of resolution bits used to generate the display of the first device and selects the appearance of the cursor in response to the number of resolution bits used.

In still another embodiment, the associator module controls the z-order of the substantially transparent window relative to other windows of the display generated by the first device.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagrammatic view of one embodiment of a networked system having multiple consumer nodes in communication with a source node to provide a screen sharing environment.

FIGS. 2A and 2B are block diagrams depicting embodiments of computers useful in connection with the present invention.

FIGS. 3A and 3B are screen shots of desktops of a source node and a viewer node, respectively, according to principles of the invention.

FIGS. 4A and 4B are screen shots of desktops of a source node and a viewer node, respectively, using an embodiment of the spotlight tool constructed according to principles of the invention.

FIGS. 5A and 5B are graphical representations of respective embodiments replacement cursors constructed according to principles of the invention.

FIG. 6 is a block diagram of an embodiment of a system for focusing attention to a particular area of a shared display according to principles of the invention.

FIG. 7 is a flow chart of an embodiment of a method of using the spotlight tool according to principles of the invention.

FIG. 8 is a diagrammatic view of a system for sharing screen data.

### DETAILED DESCRIPTION OF THE INVENTION

As an overview, one aspect of the invention replaces the current cursor of a presenter computing system that is participating in the screen sharing session with an oversized translucent cursor (also referred to as a replacement cursor or custom cursor through the specification) and transmits the translucent cursor to each participating viewer system. The resolution of oversized translucent cursor is determined on system-by-system basis. On a system where the display settings are set to thirty-two bits per pixel (highest quality, millions of colors) one embodiment of the oversized translucent cursor is represented as a thirty-two bit forty-eight pixel by forty-eight pixel cursor. On sixteen bit and eight bit systems, where thirty-two bit cursors are not supported, the current cursor of the shared screen is replaced with a replacement cursor that is a disc of dots having a size similar to the translucent disk. The replacement cursor aids the participants of the screen sharing session in focusing their attention to the desired area of the shared screen.

The invention displays replacement cursor regardless of which window in the shared screen the replacement cursor hovers over. In one embodiment, the invention uses low-level mouse hooks to intercept mouse events before they are passed to other applications of the shared environment. The invention generates and positions a “cursor helper” window directly under the replacement cursor. As used herein, a “cursor helper window” refers to a transparent window. As the replacement cursor moves, the position of the cursor helper window is continually updated so that the cursor helper window remains directly under the replacement cursor. Additionally, the cursor helper window can be sized to substantially cover the shared display. Also, the correct Z-order ordering of the windows of the shared screen is maintained. The cursor helper window is associated with the replacement cursor such that the cursor helper window is on top (in front) of the other windows on the desktop of the shared screen, but below (behind) the windows of the shared screen user interface.

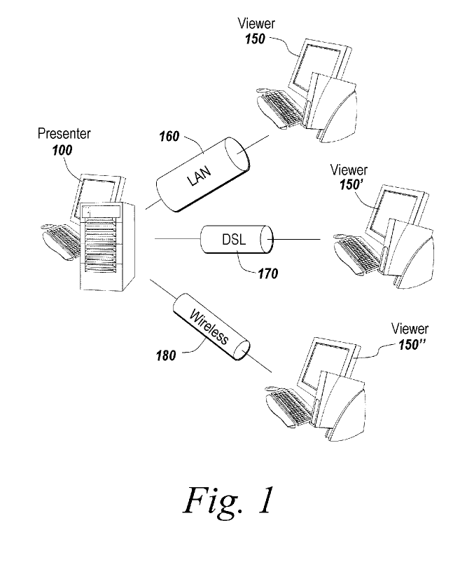

Referring now to FIG. 1, a networked system that permits a screen sharing environment has a source node 100 (also referred to as a presenter node, presenter system, host node, or host system) in communication with a number of consumer nodes 150, 150′, 150″ (also referred to as viewer nodes or viewer systems) is depicted. As shown in FIG. 1, the consumer nodes 150, 150′, 150″ may communicate with the source node 100 via networks of differing bandwidth. In the embodiment shown in FIG. 1 consumer node 150 communicates with the source node 100 via a high-bandwidth network 160, such as a local area network (LAN). Consumer node 150″ communicates with the source node 100 via a low-bandwidth network 180, such as a wireless network. Consumer node 150′ communicates with the source node 100 via a network 170 having bandwidth between the low-bandwidth network 180 and the high-bandwidth network 160, such as a Digital Subscriber Line (DSL) connection. Although only one source node 100 and three consumer nodes 150, 150′, 150″ are depicted in the embodiment shown in FIG. 1, it should be understood that the system may provide multiple ones of any or each of those components. For example, in one embodiment, the system includes multiple, logically-grouped source nodes 100, each of which may be available to provide data to a consumer node 150, 150′, 150″. In these embodiments, the logical group of source nodes 100 may be referred to as a “server farm” or “content farm.” In other embodiments, the source node 100 is a multi-user server having a virtual frame buffer, i.e., a presentation server.

The network connections 160, 170, 180 between the consumer nodes 150, 150′, 150″ and the source node 100 can be local area networks (LAN), metropolitan area networks (MAN), or a wide area network (WAN) such as the Internet. The source node 100 and the consumer nodes 150, 150′, 150″ may connect to the networks 160, 170, 180 through a variety of connections including standard telephone lines, LAN or WAN links (e.g., T1, T3, 56 kb, X.25), broadband connections (ISDN, Frame Relay, ATM), and wireless connections. Connections between the source node 100 and the consumer nodes 150, 159′, 150″ may use a variety of data-link layer communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections). Although shown in FIG. 1 as separate networks, networks 160, 170, 180 may be combined in a single physical network.

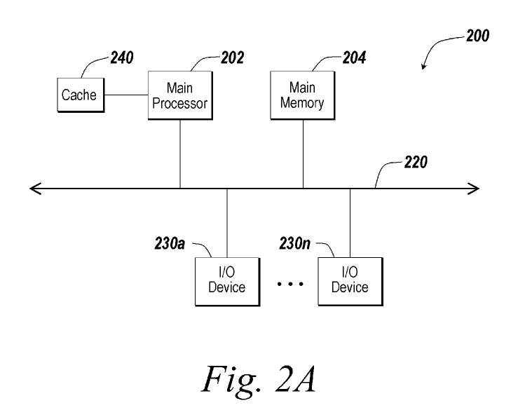

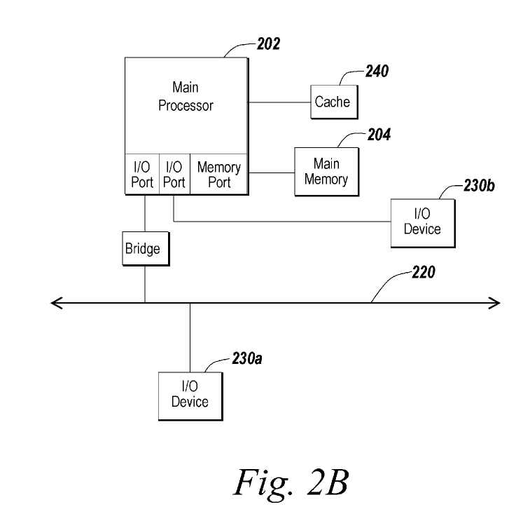

In many embodiments, the source node 100 and the consumer nodes 150, 150′, 150″ are provided as personal computer or computer servers, of the sort manufactured by the Hewlett-Packard Corporation of Palo Alto, Calif. or the Dell Corporation of Round Rock, Tex. FIGS. 2A and 2B depict block diagrams of a typical computer 200 useful as the source node 100 and the consumer nodes 150, 150′, 150″. As shown in FIGS. 2A and 2B, each computer 200 includes a central processing unit 202, and a main memory unit 204. Each computer 200 may also include other optional elements, such as one or more input/output devices 230a-230n (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM3800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athalon 64 FX, the AMD Athalon, or the AMD Duron processor, manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), Synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 200 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIGS. 2A and 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

In some embodiments the consumer node 150, 150′, 150″ is a mobile device, such as a JAVA-enabled cellular telephone or personal digital assistant (PDA), such as the i50sx, i55sr, i58sr, i85s, i88s, i90c, i95cl, or the im11000, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In other embodiments in which the client device 140 is mobile, it may be a personal digital assistant (PDA), such as the Tungsten W, the VII, the VIIX, the i705, or a combination PDA/telephone device such as the Treo 180, Treo 270 or Treo 600, all of which are manufactured by palmOne, Inc. of Milpitas, Calif.

In these embodiments, the consumer nodes 150, 150′, 150″ connect to the source node 100 using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

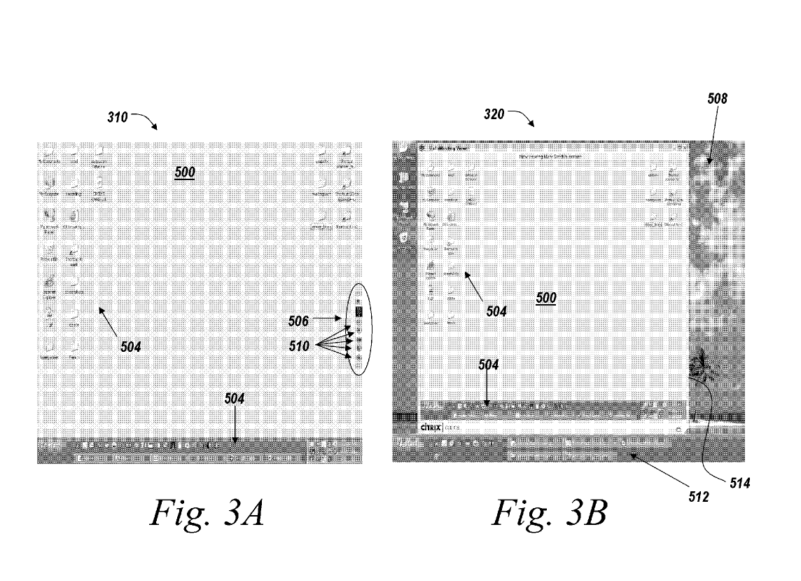

With reference to FIGS. 3A, a screen shot depicts an embodiment of a source node display 310 that is sharing display data representing a desktop environment 500 with a viewer node 150. In brief overview, the desktop environment 500 of the source node 100 includes icons, elements (e.g., toolbars, menus, and application windows), and other items that are commonly referred to as desktop environment elements 504. During a screen sharing session, the desktop environment 500 of the source node 100 includes a control panel 506 that is part of a screen sharing application or service executing on the source node 100. The control panel 506 includes various buttons 510 that provide control functionality and status of the screen sharing application. For example, the buttons 510 allow a user of the source node 100 to determine what elements of the desktop environment 500 to share, which viewer systems 150 can view the desktop environment 500, indicating whether or not the desktop environment 500 is being displayed, and tools to annotate the desktop environment.

The user of the source node 100 may choose to share the desktop environment 500 the user of the consumer node 150, which can include all or some of the desktop environment elements 504. In one embodiment, the user of the source node 100 chooses to share the display 310 to enable collaboration with the user of the consumer node 150. In another embodiment, the user of the source node 100 chooses to share the display 310 to enable training or troubleshooting. It should be understood that in some embodiments, the source node 100 may pass control to the viewer node 150. As such, the roles of source node 100 and viewer node 150 are reversed.

With reference to FIGS. 3B, a screen shot depicts an embodiment of a viewer node display 320 that is receiving shared display data representing the desktop environment 500 of the source node 100. A desktop environment 508 of the viewer node 150 includes icons, elements (e.g., toolbars, menus, and application windows), and other items that are commonly referred to as viewer desktop environment elements 512. During a screen sharing session, the desktop environment 508 displays the shared desktop environment 500 of the source node 100, including those desktop environment elements 504 chosen for sharing, in an application window 514. It should be noted that the control panel 308 of the screen sharing application is not shown to the viewer node 150. However, the functionality of the screen sharing application may allow for the source node 100 to become a viewer node 100 by allowing a viewer node 150 to share its respective desktop environment 508. In another embodiment, only portions of the functionality of the control panel 506 are provided and displayed in the application window 514. For example, annotation tools are provided to the viewer system 150.

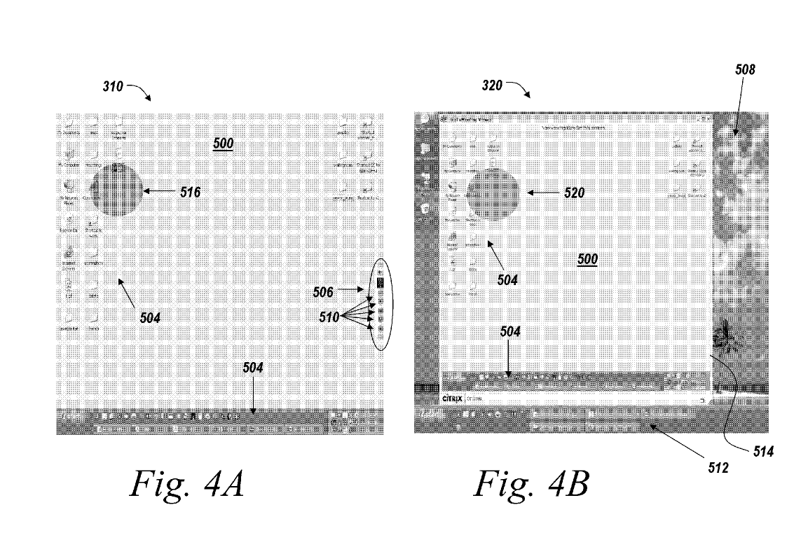

With reference to FIGS. 4A and 4B, a screen shot of each respective desktop environment 500 and 508 shows a respective replacement cursor 516, 520 that highlights a respective area of the shared desktop environment 500. In one embodiment, the replacement cursor 516 of the display 310 of the source node 100 is captured and transmitted as part of the screen data. Said another way, the replacement cursor 516 is broadcast from the source node 100 to each viewer node 150 and rendered into the shared desktop environment 500 of the viewer node 150. In one embodiment, the translucent version of the custom cursor 516 is always transmitted to the viewer node 150. In another embodiment, the replacement cursor 516 of the source node 100 is not transmitted as part of the shared screen data, but instead the local cursor 520 of the viewer node 150 is replaced by the custom cursor 516 on that system. Said another way, the source node 100 and the each viewer node 150 use its respective replacement cursor.

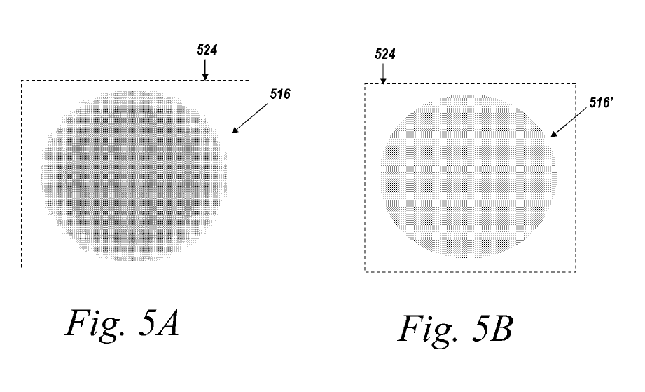

FIG. 5A depicts one embodiment of a replacement cursor 516 for use in the screen sharing environment. The replacement cursor 516 is a transparent disk (also referred to as a “spotlight tool” throughout the specification). By controlling the alpha channel in the systems having the display setting set to thirty-two bits per pixel, the cursor will appear as a translucent disk that allows the elements 504 of the desktop environment 500 remain visible therethrough. The replacement cursor 516 can have other sizes as well. The replacement cursor 516 can have a colored hue or other distinguishing characteristic. For example, the replacement cursor can be a red translucent disk that is forty-eight pixels by forty-eight pixels. It should be understood that the replacement cursor 516 can have differing sizes. In other embodiments, the shape of the cursor is a polygon. For example, the cursor can be shaped as a triangle, square, rhombus, rectangle, trapezoid, pentagon, hexagon, octagon, and the like. In addition to red, the colored hue can be green, blue, yellow, black, white, or any combination there of.

In certain operating system environments, the standard cursor behavior is for the shape of the cursor to be determined by the application window that has focus. As such, when the cursor is moved, it is possible that the cursor will change to another shape or size. Once activated, it is desirable to keep showing the replacement cursor 516 in order to focus attention to the desired area regardless of which window the replacement cursor 516 is hovering over. To achieve this, in one embodiment, a cursor helper window 524 is associated with the replacement cursor 516. In one embodiment, the cursor helper window 524 is sized such that the replacement cursor 516 is always within its boundaries. In another embodiment, the position of the cursor helper window is continually updated so that the cursor helper window remains directly under the replacement cursor 516. Also, the correct Z-order of the window of the shared display is maintained. In one embodiment, the cursor helper window remains above (in-front) all windows of the desktop environment 500, but below (behind) the windows of the screen sharing application user interface.

FIG. 5B depicts another embodiment of a replacement cursor 516′ for use in the screen sharing environment. On systems that use display setting of sixteen bits per pixel and eight bits per pixel (systems where thirty-two bit cursors and alpha channels are not supported), one embodiment of the replacement cursor 516′ is a similar sized disc of dots having a colored hue. In other embodiments, the shape of the cursor is a polygon. For example, the cursor can be shaped as a triangle, square, rhombus, rectangle, trapezoid, pentagon, hexagon, octagon, and the like. In addition to dots, the disk can be constructed of other shapes such as triangles, squares, rhombuses, rectangles, trapezoids, pentagons, hexagons, octagons, and the like. In addition to red, the colored hue can be green, blue, yellow, black, white, or any combination there of.

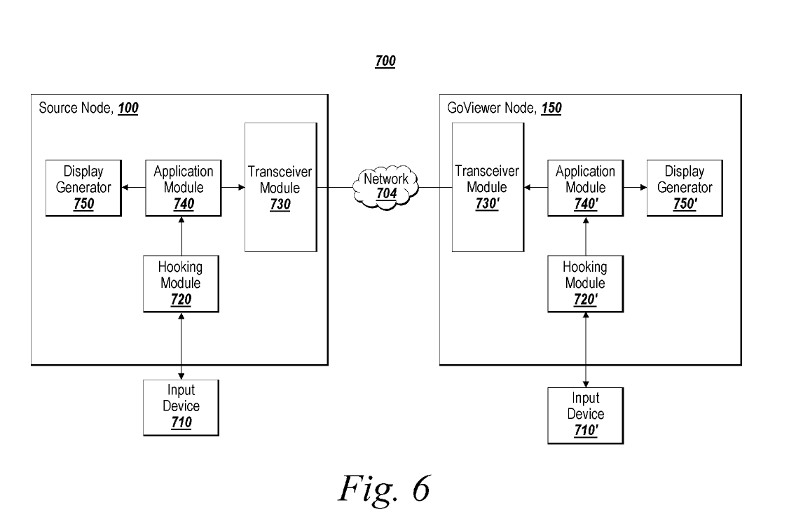

FIG. 6 depicts a block diagram of a system 700 for focusing attention to a particular area of the shared display. In one embodiment, the system 700 includes a source node 100 in communication with a viewer node 150 through a network 704. Input device commands and position information are hooked at the source node 100 and transmitted to the viewer node 150 to be executed locally by the viewer node 150.

In one embodiment, the source node 100 includes an input device 710, a hooking module 720, a transceiver 730, one or more applications 740 (e.g., the screen sharing application), and a display generator 750. The hooking module 720 is in communication with the input module 710 and the application 740. The transceiver module 730 is in communication with the application 740 and the network 700. The application 740 is also in communication with the display generator 750. In one embodiment, the hooking module 720, the transceiver 730, and display generator 740 can be implemented as a software such as an application, a module, a service, a computer program, a software component, a web service, a web component, a web page, a library, a function, a script, an interpreted language, or any other type and/or form of executable instruction.

In one embodiment, the viewer node 150 includes an input device 710′, a hooking module 720′, a transceiver 730′, one or more applications 740′ (e.g., the screen sharing application), and a display generator 750′. The hooking module 720′ is in communication with the input module 710′ and the application 740′. The transceiver module 730′ is in communication with the application 740′ and the network 700′. The application 740′ is also in communication with the display generator 750′. In one embodiment, the hooking module 720′, the transceiver 730′, and display generator 740′ can be implemented as a software such as an application, a module, a service, a computer program, a software component, a web service, a web component, a web page, a library, a function, a script, an interpreted language, or any other type and/or form of executable instruction. The hooking module 720′ generally does not hook mouse commands from the viewer node 150 unless the viewer node 150 becomes the source node 100 during the screen sharing session.

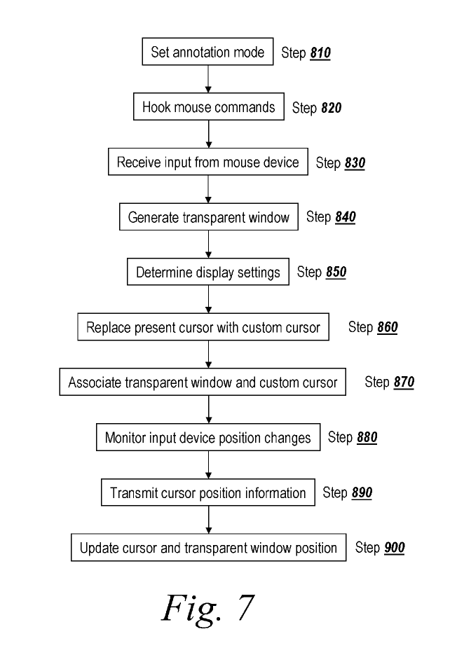

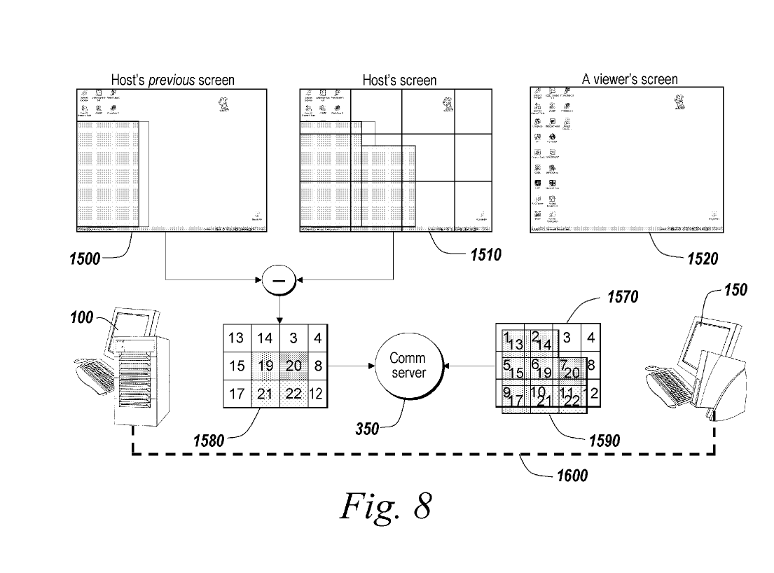

With reference to FIG. 7, and in brief overview, the operation of the system 700 of FIG. 6 is described. A user sets (step 810) the system 700 to the annotation mode. The system 700 begins hooking (step 820) mouse commands and receiving (step 830) input from the input device 710. In response, the system 700 generates (step 840) a transparent window 524, determines (step 850) the display settings of the source node 100, replaces (step 860) the present cursor with the custom cursor 516, and associates (step 870) the transparent window 524 with the custom cursor 516. The system 700 continues to monitor (step 880) changes in the x/y position of the input device 710, transmit (step 890) the position changes to the viewer node 150, and update (step 900) the location of the transparent window 524 and the custom cursor 516.

In one embodiment, the user selects a button 510 of the control panel 506 of the screen sharing application. In one embodiment, the selected button 510 provides the user with a plurality of tools capable of annotating the shared desktop environment 500. Upon selection of an annotation tool (e.g., the spotlight tool), the screen sharing application enters the annotation mode (step 810). In other embodiments, a keyboard shortcut, hotkey, voice command, or other input event can select the button 510 and activate the annotation mode.

After activation of the annotation mode, the screen sharing application begins hooking (step 820) mouse commands. In one embodiment, a WINDOWS programming command such as WH_MOUSE_LL is used to hook the mouse commands. The WH_MOUSE_LL hook command provides monitoring of mouse input events about to be posted in a thread input queue.

The hooking module 720 receives (step 830) input commands from the input device 710. In one embodiment, the input commands are click and hold events of the left mouse button along with other mouse event such as right clicks, left clicks, and mouse move events. In other embodiments, the input commands can include voice commands, pen clicks, and the like.

After receiving input, the screen sharing application positions (step 840) a substantially transparent (“cursor helper”) window 524 directly below the cursor. In one embodiment, a transparent window 524 is generated solely at the source node 100. In another embodiment, a transparent window is generated at the source node 100 and each viewer node 150. Said another way, in this embodiment the transparent window 524 is local to each system executing the screen sharing application. The substantially transparent window 524 is a layered window as defined in WINDOWS programming. For example, programming commands such as SetLayeredWindowAttributes and UpdatedLayeredWindowAttibute provide a means to control the transparency of the layered windows.

A determination module (not shown) of the application 740 determines (step 850) the display setting for the source node 100. In one embodiment, the display settings are read from a memory location or graphics card storing the requested information. In other embodiments, the information is inputted manually by the user of screen sharing application.

The application 740 replaces (step 860) the present cursor with a custom cursor 516 at the source node as previously described. In one embodiment, if the display settings of the source node 100 indicate that thirty-two bits per pixel are in use then the custom cursor 516 is a thirty-two bit red translucent disk that is forty-eight pixels by forty-eight pixels. If the display settings of the system indicate sixteen or eight bits per pixel are in use, then the custom cursor 516′ is a similarly sized disc of dots. In other embodiments, the user is able to select a desired custom cursor 516 and control the transparency of the custom cursor 516. In still another embodiment, the custom cursor is selected automatically in response to the information being shared. For example, if the source node 100 is sharing a presentation, the custom cursor 516 is selected to provide an appropriate level of highlighting.

The screen sharing application associates (step 870) the transparent window 524 and the custom cursor 516 with one another. In one embodiment, the custom cursor shape 516 is specified as the default cursor shape for the cursor helper window 524. If the size of the cursor helper window 524 is such that is covers the entire desktop environment, the custom cursor 516 will be continually displayed regardless of its location. In another embodiment, a smaller cursor helper window 524 is used and moves as the custom cursor 516 is moved.

As the user of the source node 100 manipulates the input device, the screen sharing application monitors (steps 880) changes to the position of the custom cursor 516. The x and y coordinates of the mouse are captured using the mouse hooking commands as previously described. In one embodiment, the hooking module 720 captures the position and changes in position of the input device 710.

In one embodiment, the transceiver 740 transmits (step 890) the custom cursor 516 and its position to the each of the viewer nodes 150 and through the network 704. In another embodiment, the actual x and y position is transmitted to viewer node 150 and each viewer node 150 receives the updated input position information and updates (step 900) the position of the local custom cursor 516 and the local cursor helper window 524.

The described systems and methods can be used to implement a system for sharing screen data that allows several viewer systems to display and highlight the screen data from a single presenter system. This system is useful in a number of broadcast or “multicast” contexts and, in particular, it is useful in a conferencing context to allow multiple individuals to view the same graphical data during the conference.

FIG. 8 depicts diagrammatically a system for sharing screen data. As shown in FIG. 8, a presenter system 100 monitors its screen state. In the embodiment shown in FIG. 8, the presenter system 100 subdivides its screen into twelve tiles, although any number of tiles may be used to fully represent the screen of the presenter system 100. In some embodiment the tiles are each the same size, that is, each tile represents the same number of screen pixels. In other embodiments, some of the tiles have sizes different from other tiles. In still other embodiments, a tile may overlap another tile or, as shown in FIG. 8, tiles may be non-overlapping.

As shown in FIG. 8, the presenter system's previous screen 1500 is represented by a first set of tiles (not shown), which are coded as a first set of data packets: 13, 14, 3, 4, 15, 6, 7, 8, 17, 10, 11, and 12. If the presenter system 100 possesses a transmission token, it transmits these twelve data packets to a communications server 350. As used herein, communications server refers to a device, process, or thread capable of transmitting data packets to a destination.

At a second point in time, the presenter system's screen 1510 has changed. The presenter system 100 identifies the particular tiles that have changed states, and creates a coded packet for each tile that has changed, i.e., data packets 19, 20, 21, and 22. If the presenter system 100 did not possess a transmission token but now receives one, the presenter system 100 will transmit the updated twelve data packets to the communications server 350, i.e., data packets 13, 14, 3, 4, 15, 19, 20, 17, 21, 22, and 12. If the source server has already transmitted the data packets representing the state of the previous screen 1500, then the presenter system 100 need only transmit to the communications server 350 data packets 19, 20, 21, and 22. In this manner, transmission of screen data between the presenter system 100 and the communications server 350 is performed in a bandwidth-adaptive manner.

In some embodiments, the presenter system 100 encrypts the data packets transmitted to the communications server 350. In other embodiments, the presenter system 100 compresses the data packets sent to the communications server 350. In still other embodiments, the presenter system 100 both encrypts and compresses the data packets.

In one embodiment, in addition to sending screen data through the communication server 350, the present invention can establish a virtual channel 1600 transmit the custom cursor 516, cursor helper window commands, and input device position information to each of the viewer nodes 150. In one embodiment, the virtual channel 1600 establishes a direct connection with each viewer node 150. In other embodiments, the virtual channel 1600 is established with the communication server 350, which in turn, broadcasts the custom cursor 516, cursor helper window commands, an the input device position information to each of the viewer nodes 150.

In many embodiments, the communications server 350 maintains a copy of each tile that comprises the most recent state of the server node screen. In some embodiments, each tile is associated with a timestamp when transmitted to the communication server 350. In other embodiments, each tile is associated with a number that monotonically increases with each new tile transmitted to the communications server 350.

The communications server 350 composes an update for a viewer node 150 as often as the bandwidth of the network connecting the viewer node 150 to the communications server 350 allows. As shown in FIG. 9, the viewer's screen 1520 displays screen data from a point in time before the presenter's previous screen 1500. That is, the source server's display data has changed twice (represented by screen 1500 and screen 1510) since the last time the viewer node 150 has requested an update. Data packet array 150 shows the data packets comprising the screen data currently displayed by the viewer node 150. Data packet array 1590 depicts the data packets that the communications server 350 must transmit to the viewer node 150 in order to update the viewer's screen 320 to the state of the presenter's screen 310. As described above, the communications server 350 transmits metadata information to the viewer node 150 identifying eight data packets: data packets 13, 14, 15, 19, 20, 17, 21, and 22. In some embodiments, the metadata information explicitly identifies which tile replaces which other tile, perhaps by describing the position of the new tile. The communications server 350 then transmits the packets representing the new tiles to the viewer node.

In another embodiment, the communication server 350 responds to an update request from the viewer node 150 by transmitting to the viewer node 150 every data packet having a timestamp newer than the timestamp of the viewer's screen. In some of these embodiments, the communication server 350 does not fully receive and store a set of data packets comprising a screen update before sending the update to the viewer node 150. In these embodiments, the communications server 350 sets the timestamp for each packet identified by metadata information as comprising the screen update to the same value. Then, as data packets arrive the communications server 350 streams those packets to the viewer node 150.

In one particular embodiment, metadata information is formatted into packets and metadata packets are associated with monotonically increasing numbers. As described above, each metadata packet describes the set of tiles comprising the current screen display state. In this embodiment, the communications server 350 stores, for each consumer node 150, the number of the latest metadata packet that has been transmitted to that consumer node 150, as well as the set of all data packets that have been delivered to the consumer node. When the communications server 350 determines that it is time to send an update to a consumer node 150, or upon receiving a request from a consumer node 150 for a screen update, the communications service first determines if the latest metadata packet (that is, the metadata packet having the highest number associated with it) has been transmitted to the consumer node 150. If not, the communications server 350 transmits the most recent metadata packet to the consumer node 150. The communications server 350 also transmits the set of data packets identified by the metadata packet, unless a particular data packet has already been transmitted to the consumer node 150.

The previously described embodiments may be implemented as a method, apparatus or article of manufacture using programming and/or engineering techniques to produce software, firmware, hardware, or any combination thereof. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.), a file server providing access to the programs via a network transmission line, wireless transmission media, signals propagating through space, radio waves, infrared signals, etc. The article of manufacture includes hardware logic as well as software or programmable code embedded in a computer readable medium that is executed by a processor. Of course, those skilled in the art will recognize that many modifications may be made to this configuration without departing from the scope of the present invention.

Although the present invention has been described with reference to specific details, it is not intended that such details should be regarded as limitations upon the scope of the invention, except as and to the extent that they are included in the accompanying claims.

What is claimed as new and desired to be protected by Letters Patent of the United States is:

1. A method of highlighting a portion of a display generated by a first device, the display shared with a second device, the method comprising:
(a) associating a substantially transparent window with the location of a cursor to position the cursor within the substantially transparent window; and
(b) changing the appearance of the cursor to highlight a portion of the display.

2. The method of claim 1 further comprising moving the location of the substantially transparent window as the position of the cursor changes such that the cursor remains associated with the substantially transparent window.

3. The method of claim 1 further comprising intercepting a mouse event from an input device prior to passing the event to an application executing in the shared windows environment.

4. The method of claim 1 wherein changing the appearance of the cursor comprises changing the appearance of the cursor to a translucent disk.

5. The method of claim 1 further comprising determining the number of resolution bits used generate the display of the first device and selecting the appearance of the cursor in response to the number of resolution bits used.

6. The method of claim 1 wherein (a) and (b) are performed at each of the first device and the second device.

7. The method of claim 1 wherein the associating comprises controlling the z-order of the substantially transparent window relative to other windows of the display generated by the first device.

8. A system for highlighting a portion of a display generated by a first device, the display shared with a second device, the system comprising
means for associating a substantially transparent window with the location of a cursor to position the cursor within the substantially transparent window; and
means for changing the appearance of the cursor to highlight a portion of the display.

9. The system of claim 8 further comprising means for monitoring the movements the location of the substantially transparent window as the position of the cursor changes such that the cursor remains associated with the substantially transparent window.

10. The system of claim 8 further comprising means for intercepting a mouse event from an input device prior to passing the event to an application executing in the shared windows environment.

11. The system of claim 8 wherein the means for changing the appearance of the cursor changes to the cursor to a translucent disk.

12. The system of claim 8 further comprising means for determining the number of resolution bits used generate the display of the first device and means for selecting the appearance of the cursor in response to the number of resolution bits used.

13. The system of claim 8 wherein the means for associating comprises means for controlling the z-order of the substantially transparent window relative to other windows of the display generated by the first device.

14. A system for highlighting a portion of a display generated by a first device, the display shared with a second device, the system comprising:
an associator module in communication with an input device to receive input commands, the associator locating a substantially transparent window behind a cursor; and
a display generator in communication with associator module, the display generator changing the appearance of the cursor to highlight a portion of the display.

15. The system of claim 14 further comprising a hooking module in communication with the input device, the hooking module monitoring the movements the location of the substantially transparent window as the position of the cursor changes such that the cursor remains associated with the substantially transparent window.

16. The system of claim 14 further comprising a hooking module in communication with the input device, the hooking module intercepting a mouse event from the input device prior to passing the event to an application executing in the shared windows environment.

17. The system of claim 14 wherein the display generator changes the appearance of the cursor to a translucent disk.

18. The system of claim 14 further comprising a determination module in communication with the display generator, the determination module determining the number of resolution bits used generate the display of the first device and selecting the appearance of the cursor in response to the number of resolution bits used.

19. The system of claim 14 wherein the associator module controls the z-order of the substantially transparent window relative to other windows of the display generated by the first device.
